(19) United States
(12) Patent Application Publication
(10) Pub. No.: US 2002/0001191 A1
(43) Pub. Date: Jan. 3, 2002

(54) METHOD AND APPARATUS FOR JOINING AND ALIGNING FIXTURES

(76) Inventors: DEAN GRIERSON, WHEATRIDGE, CO (US); PATRICK HERSCO, WHEATRIDGE, CO (US)

Correspondence Address: THOMAS J. ROSSA, ESQ., HOLME ROBERTS & OWEN LLP, 111 EAST BROADWAY, SUITE 1100, SALT LAKE CITY, UT, 84111-5233, US

(21) Appl. No.: 09/079,905

(22) Filed: May 15, 1998

(51) Int. Cl. F21S 4/00

(52) U.S. Cl. 362/219; 362/225; 362/457; 403/292

(57) ABSTRACT

Apparatus and method for joining and aligning fixture modules in an end-to-end relationship, utilizing paired interlocking connectors. The apparatus and method are particularly suited for connecting fluorescent light modules which are suspended from a wall or ceiling, with minimal end-to-end distance between the ends of the fluorescent light tubes in adjacent modules. The connectors are placed at the ends of the modules, with a body portion of each connector adjacent a module end. Tapered tabs, joined to at least one body portion of each pair of connectors, are insertable through tapered openings in the body portion of the other connector in the pair to connect the two modules to each other. The tabs and openings are adapted for interconnection in at least two positions, including a first position for supporting an end of one of the modules while the module is hung and while electrical connections are made between the modules, and a second position where the tabs are fully inserted through the body portion of the adjacent connector to interlock the connectors. The tapered sides of the tabs and the openings aid in aligning the modules as the tabs are inserted through the openings. Each connector may be constructed from a single piece of a suitable material.

### FIELD OF THE INVENTION

The present invention relates generally to the field of modular fixtures for architectural applications, and in particular to connectors for connecting a series of modules to form an elongated fixture. The invention is particularly useful for assembling elongated light fixtures such as are used in suspended, indirect lighting applications.

### BACKGROUND OF THE INVENTION

There are a number of architectural settings in which arrays of interconnected modular fixtures are installed. For example, arrays of modular light fixtures can be suspended from a ceiling or otherwise supported, such as by mounting on a wall, in a linear, circular, polygonal, or other geometric array. However, installation of such arrays generally requires that the individual modules of the fixture be physically connected to each other in a precise alignment, both to ensure structural stability of the array and to create an esthetically pleasing appearance.

Installation and alignment of many existing types of suspended arrays require considerable time and labor to ensure proper and precise three-dimensional alignment. In particular, it is typically necessary to support both ends of an initial module while it is being suspended from a wall or ceiling or other support structure, and also while it is being physically connected to an adjacent module. In this regard, one worker typically holds the initial module while another worker attaches hangers at each end of the module. For subsequent modules, the modules are attached by a hanger at one end and to a previously hung module at the other end. For example, one worker may hold the module while another worker attaches the hanger. While the first worker continues to hold the unsupported end, the other worker can then carefully align the module with the previously hung module and use fasteners or the like to interconnect the modules. Installation procedures may be even more complex and time-consuming when additional parts must be positioned within or between fixtures. In the case of light fixtures and other electrical fixtures, for example, it is also necessary to make electrical connections between the fixtures. These operations may have to be conducted in physically cramped and awkward work spaces, where it is difficult to position mechanical parts. It will thus be appreciated installation and alignment is generally time-consuming, labor intensive and expensive.

In some settings, it is desirable to have arrays of modular fixtures for fluorescent light tubes in which the tubes can be mounted in a manner which minimizes the distance between the ends of tubes in adjacent fixtures to provide a pleasing appearance, more uniform illumination, and/or efficient use of available space for mounting fixtures. For example, fluorescent bulbs are typically available in predetermined lengths, for example, four feet. A designer or client may desire to provide a fixture having a cumulative length of sixteen feet. If such a fixture was assembled using four modules with conventional fixtures having connectors between modules that occupy, perhaps, two or more inches, the resulting fixture could be half a foot or more larger than the desired length. Additionally, at each connection, a dark spot will appear, thereby damaging the illusion of a continuous, customized fixture. It is therefore desirable to minimize the length of connections. However, decreasing the space between the modules and, consequently, the ends of the bulbs, can result in decreased working space for making mechanical and electrical connections between the modules.

### SUMMARY OF THE INVENTION

It is an object of the present invention to provide a system and method which allow connection and alignment of modules into fixtures with reduced labor requirements.

It is another object of the present invention to provide a system and method for connecting fluorescent light modules end to end in fixtures with decreased space between the ends of the fluorescent tubes in adjacent modules.

It is yet another object of the present invention to provide a connector and a method for installing modules rapidly and easily in precise three-dimensional alignment.

It is still another object of the present invention to provide a mechanism which supports the fixtures and free both hands of a worker to make electrical connections.

It is a further object of the present invention to provide a connector and a method for connecting modules utilizing fewer parts and that is less labor intensive than conventional installations.

It is still a further object of the present invention to provide a connector for modular fixtures which can be easily and inexpensively manufactured from readily available and inexpensive materials, and a method for manufacturing such a connector.

These and other objectives are addressed by the connector system of the present invention.

The present invention is directed to connecting and aligning modules of modular fixtures, which may be suspended in an abutted end-to-end configuration from above or from a vertical wall. The present invention simplifies installation of fixtures, with decreased labor requirements relative to previous installation methods. In accordance with the present invention, connectors are mountable to fixtures, preferably substantially inside of and at the ends of the fixture modules.

The fixtures may be electrical fixtures, and more particularly, they may be fluorescent light fixtures. In this regard, connectors are adapted and mountable to the fixtures in a manner that allows fluorescent light tubes in adjacent modules to be aligned end-to-end, with minimal space between the tubes. In addition to using the available space more efficiently for mounting the fixtures, this arrangement of the light tubes eliminates dark spots which detract from the appearance of the fixture array and could decrease the uniformity of the illumination of the space in which the fixtures are mounted.

In accordance with the present invention, when modules are installed in an end-to-end configuration with the end of one module adjacent the end of another module, the connectors at those ends interlock with each other so as to cause the fixtures to be aligned with each other. To achieve this interlocking and self-aligning relationship, at least one of each pair of connectors (e.g., mating connectors of adjacent modules) includes at least one tab member, and at least the other of the two paired connectors includes at least one opening, preferably with a wide central portion and tapered sides. Each tab member also preferably tapers from a wide portion adjacent a joint between the tab member and a body portion of the connector to a narrower portion which is distal from the joint, and each tab member can be positioned to extend outward from the end of the module to which it is mounted. Preferably, the tab member(s) is deployable from a first position where the tab member is flush with the body portion (e.g., for shipping and handling) and a second position where it extends from the body portion for engaging the connector of an adjacent module.

The tab member(s) and the opening(s) are sized and positioned such that an extended tab member of one connector can be inserted through an opening of another connector to engage the connectors in at least two interlocking positions. In one interlocking position, the two connectors are close enough to each other to allow a worker to access the ends of both fixtures easily during installation of the fixtures, such as for making electrical connections, and provide adequate work space for moving the connected wires to a position where they will be invisible when installation is complete. Additionally, in this first interlocking position, one end of a module being installed can be supported by a previously hung module while the other end is suspended, thereby simplifying installation and reducing labor requirements. To facilitate engagement of the tab with the opening in the first position, the tab member may terminate in a hook distal from the joint between the tab and the body portion of the connector to which it is joined.

In the second position, the connectors are engaged such that the ends of the two fixtures abut each other, and the electrical wires are inside the fixtures and hidden from view. In a preferred embodiment, the tab member and the opening are sized and positioned such that the tapered sides of the tab member engage the tapered sides of the opening into which the tab is inserted as the two connectors are moved toward each other from the first position to the second position, and the wider portion of the tab member adjacent the joint is simultaneously and progressively guided to the widest portion of the corresponding tapered opening. The tabs and openings are also positioned such that, when connectors are in the second position, the fixtures to which the connectors are mounted are also aligned with each other. The connections between modules are thus self-aligning, as well as convenient to use and compact.

Preferably, each connector associated with each module end includes both a tab and an opening. More preferably, the connectors are identical, and the openings and tabs are positioned such that any two of the connectors can be paired, with one connector rotated 180 degrees relative to the other such that each tab member corresponds with an opening in the other connector in the pair. That is, the connectors are preferably of identical construction and are capable of mating engagement when arranged in mirror-image pairs. In this manner, construction is simplified and it is unnecessary to arrange modules in male-female series for assembly.

One aspect of the present invention involves a self-aligning engagement structure. The structure includes a body portion having at least one opening sized and shaped to accommodate a tapered tab connector from a connector on an adjacent fixture. The body portion may also include a tapered tab connector, as described above, joined to the body portion at a joint. Preferably, the wide portion of the opening and the joint between the tab member and the body portion located on opposite sides of a centerline of the assembled fixture. If the engagement structure is used for connecting light fixtures, the body portion preferably is adapted for enclosing electrical wires running between fixtures and for passing a power line into a module to which the connector is mounted. The body portion may also be adapted for supporting the fixture, such as by suspension from above or from a wall. The tab member preferably terminates in a hook for engaging an opening of an adjacent connector.

Another aspect of the present invention involves a method for making interlocking connectors for interconnecting modules of a modular fixture. The method includes the steps of providing a workpiece such as a flat sheet of metal, dimensioning the workpiece so as to allow the workpiece to be mounted to an end of one of the modules, bending the workpiece to form an end wall and a support section on opposite sides of a bend, and forming a tab connector on the end wall. The end wall may also include a tapered opening for receiving a tab connector of an adjacent module. The steps of dimensioning the workpiece and forming the tab connector involve, for example, cutting the workpiece such as by laser cutting or high precision punching. In the case where the fixture is a fluorescent light fixture, the method may further involve the steps of forming a support contour in the support section for engaging an end portion of a fluorescent light tube and forming a pass-through in the end wall and/or support section for passing electrical wires between adjacent modules. A separate or integral hanger attachment may be provided in connection with the interlocking connector for use in hanging the fixture. By virtue of such construction, the connector can be formed in large part from a single workpiece, thereby simplifying construction and reducing costs.

In yet another aspect, the present invention comprises a system for connecting and aligning fixture modules in an end-to-end relationship. In the system, there are at least two modules, each having a first end and a second end, and two connectors. The first connector includes a first body portion adapted for mounting at the first end of a first module and at least one tab member adapted for extension from the body portion beyond the first end of a module to which it is mounted. The second connector includes a second body portion adapted for mounting at the second end of the second module, with at least one tapered opening positioned to receive an extended tab member of the first connector. When the connectors are mounted to modules and interlocked with each other, the modules are forced into an aligned, butting relationship. The connectors may also be adapted to accommodate fasteners, such as screws or bolts, for securing adjacent connectors to each other to provide structural integrity for the fixture array.

According to a still further aspect of the present invention, a method is provided for installing modules to form a fixture. The method includes the steps of: providing first and second modules, the first module having a tab connector on an end thereof and the second connector having an opening on an end thereof; connecting one of the modules to a support structure; inserting the tab connector of the first module into the opening of the second module to engage the modules in a first interlocking position where relative longitudinal motion between the modules is constrained (e.g., the modules resist moving apart); with the modules engaged in the first position, connecting the other of the modules to a support structure and/or running electrical wires between the modules; and progressively receiving the tab within the opening such that the modules are engaged in a second position wherein the modules are in an aligned abutting relationship. This two position process allows the modules to be preliminarily engaged for support, for example, while one of the modules is being hung or electrical connections are being made, thereby reducing the complexity or labor requirements of installation, and allows for simple alignment of the modules.

### DESCRIPTION OF THE DRAWINGS

The present invention can be understood with reference to the following drawings, wherein:

FIG. 1 is a perspective view of a linear modular light fixture suspended from a ceiling by sections of flexible cable, with the modules connected in accordance with the present invention;

FIG. 2 is a perspective view of a connector in accordance with one embodiment of the present invention;

FIG. 3 is a plan view of a piece of sheet metal having cut edges and openings, suitable for making the embodiment shown in FIG. 2;

FIG. 4 is a perspective view showing a connector of the present invention which has been inserted into the end of a module;

FIG. 5(a) is a perspective view from below showing one module which has been suspended in position with a connector according to the present invention mounted at the end of the module and showing an adjacent module, prior to connection with the first module, with a second connector according to the present invention mounted at the end adjacent the first module;

FIG. 5(b) is a partial cutaway side view of the modules shown in FIG. 5(a), with connector tabs of the adjacent connectors engaged in accordance with the present invention;

FIG. 5(c) is a top perspective view of the modules shown in FIGS. 5(a) and 5(b), with the modules aligned and connected to each other in accordance with the present invention;

FIG. 6(a) is a perspective view of connector in accordance with another embodiment of the present invention; and

FIG. 6(b) is a perspective view of another connector in accordance with yet another embodiment of the present invention.

### DETAILED DESCRIPTION

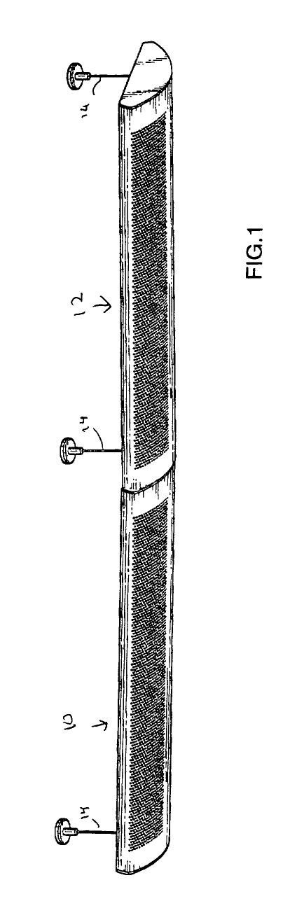

The present invention relates to supported modular fixtures for use in architectural applications. These fixtures may be supported in any manner known to those skilled in the art, including suspension from above or from the side. In accordance with the present invention, the fixture modules 10 and 12 may be light fixture modules in a linear array, as shown in FIG. 1. Although only two modules 10 and 12 are shown in FIG. 1, any number of modules may be connected end-to-end, depending on the needs for a particular architectural setting. Alternatively, two or more modules may be arrayed in any geometric relationship. However, the preferred modules of the present invention are in physical contact with adjacent modules, with the modules mechanically connected to and aligned with each other, such that the outer surfaces present a substantially continuous appearance.

Any suspension device known in the art may be utilized. Preferred suspension devices include aircraft cable 14, as shown in FIG. 1, and rigid stems. Although not shown, one or more electrical cables may be used to provide power to modules 10 and 12, and the cable or cables wires may be incorporated into one or more of the support devices 14. For simplicity, the following discussion describes modules which are suspended from above, such as from a ceiling or other structural element. However, other means of support may be utilized, such as support from below on pedestals or from the side.

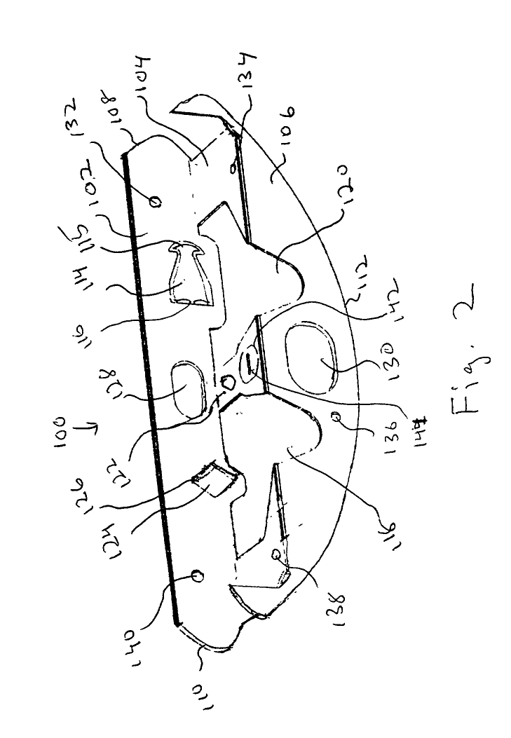

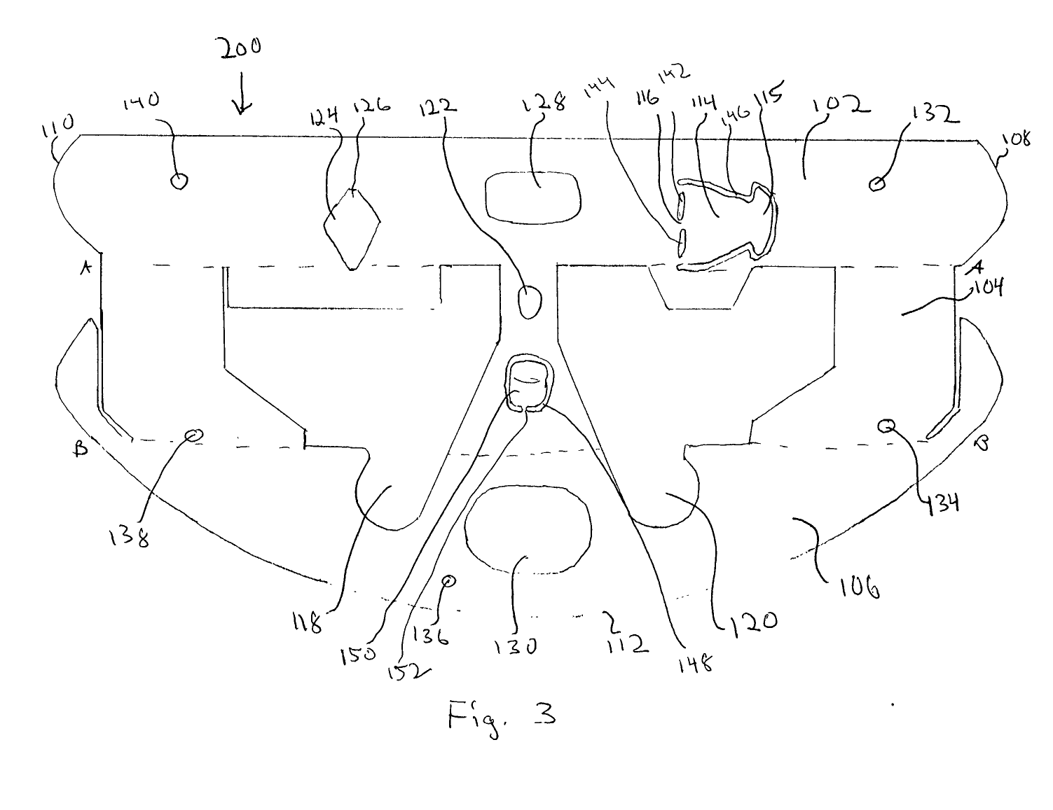

In accordance with one embodiment of the present invention, modules are joined by connectors, one of which is shown generally as 100 in FIG. 2. Connector 100 has a substantially planar wall member 102, a substantially planar fixture support member 104, and a substantially planar light tube support member 106. Fixture support member 104 is joined to wall member 102 and fixture support member 104 such that wall member 106 and fixture support member 104 are maintained in a substantially parallel relationship to each other and perpendicular to fixture support member 104. Outer edges 108, 110, and 112 of light tube support member 104 and wall member 106 are contoured for friction fitting inside a module, such as module 10 or 12 in FIG. 1.

Tab member 114 is attached to wall member 102 at joint 116. Although shown as substantially coplanar with wall member 102, tab member 114 can be extended substantially perpendicularly from wall member 102 in a direction away from fixture support member 104 and light tube support member 106. In this manner, the tab member 114 can be maintained flush with the wall member 102 for convenient shipping and handling and then deployed to an extended position (e.g., by hand or using a screwdriver or other tool) for engaging a connector of an adjacent module. Tab member 114 is widest adjacent joint 116 and wall member 102 and tapers to a smaller width distal from the joint. Preferably, tab member 114 terminates in a hooked end 115. It will be appreciated that the axis of the joint 116 must be carefully positioned to provide proper alignment of the connected module.

Connector 100 is also adapted to accommodate several types of hardware which may be necessary for proper functioning of the fixtures. Openings 118 and 120 accommodate wiring for receptacles for the ends of fluorescent light tubes. These receptacles may be of a type well known in the art for supporting and making electrical contact with metal prongs at the ends fluorescent light tubes. An insert may be fitted into opening 122 for securing connector 100 to the end of a cable, stem, or other suspension device.

Opening 124 in wall member 102 is adapted for insertion therethrough of a tab member 114 of an adjacent connector, as will be discussed below. In this regard, opening 124 has a section 126 with dimensions closely matched to the dimensions of the widest portion of tab member 114. Section 126 and joint 116 are located on opposite sides of a center (generally indicated by line 127) and, more preferably, are positioned symmetrically with respect to the center of wall member 102, for reasons which will become apparent below. The size of opening 124 decreases with increasing distance from section 126. Opening 128 aids in attachment of a hanging device, such as 14. Opening 130 is adapted to accommodate electrical wires and cables. Openings 132,134, 136, 138, and 140 are sized and positioned to accommodate fasteners, such as screws or bolts.

In a preferred embodiment, connectors, such as 100, can be manufactured from sheet metal, as shown in FIG. 3. A flat work piece 200 is cut from the sheet metal, with edges 108, 110, and 112 shaped and sized for fitting into fixture 10 or 12. The outline of tab member 114 and joint 116 between tab member 114 and wall member 102 are defined by cutting openings 142, 144, and 146. Opening 124 is cut to accommodate a tab from another connector. Openings 118 and 120 are cut into piece 200, with shapes appropriate for the wiring of particular light tube receptacles to be used with the fixture.

Openings 130 and 148 are cut to accommodate electrical cables and wires which may be need to connect modules. As shown, opening 148 defines the outline of a removable plug 150 which is attached to the fixture support member 104 at joint 152. Plug 150 may be easily removed subsequently, if necessary, by bending plug 150 back and forth or otherwise severing the connection at joint 152. Screw holes 132 and 140 are cut at appropriate locations for subsequent use in attaching the connector 100 to another connector, as described below.

The openings, edges, and other features of work piece 200 may be cut in any order or simultaneously, by any means known in the art. Preferably, a laser cutting device or high precision punching device is utilized to enhance the precision and accuracy of the cutting process and thus the fit between the connector and module housing, as well as the resulting alignment of the modules. After cutting is complete, manufacturing of connector 100 is completed by bending piece 200 along lines A-A and B-B so that wall member 102, fixture support member 104, and light tube support member 106 are arranged as shown in FIG. 3.

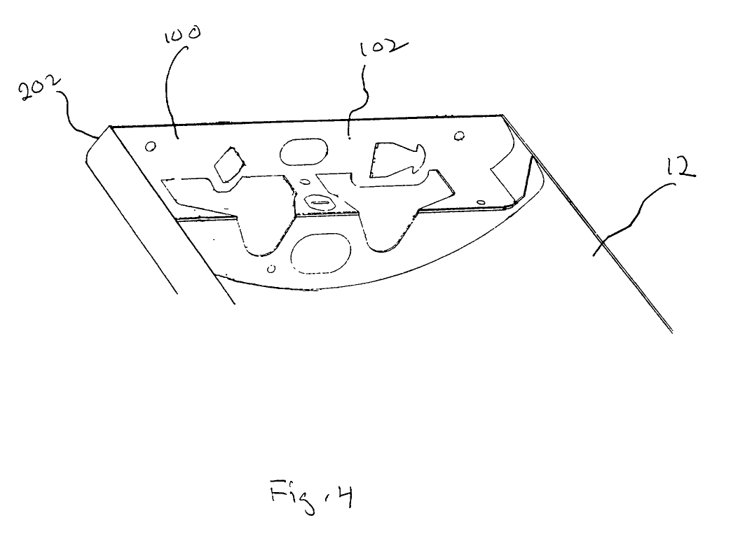

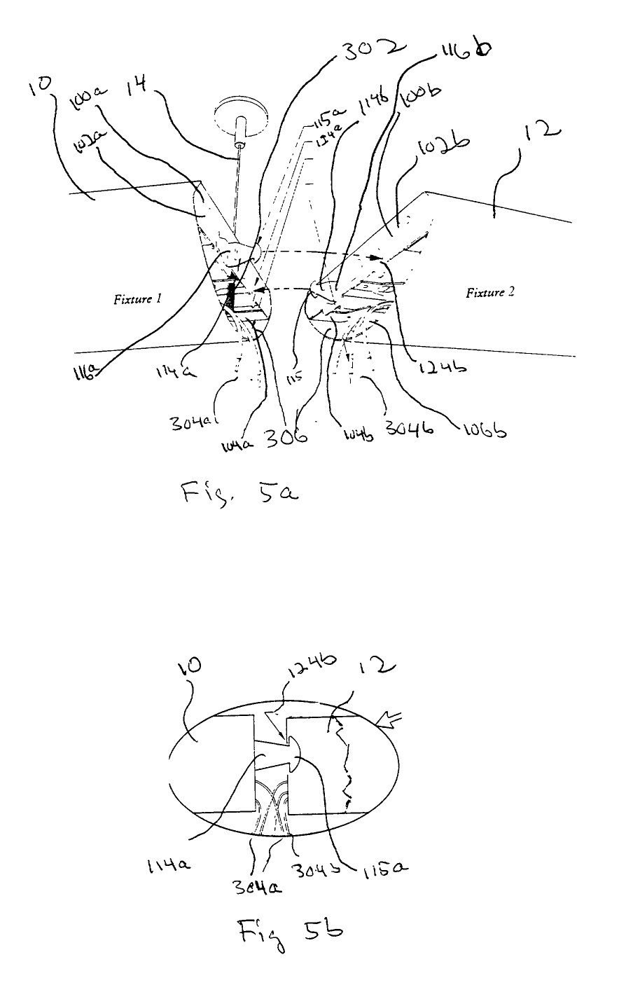

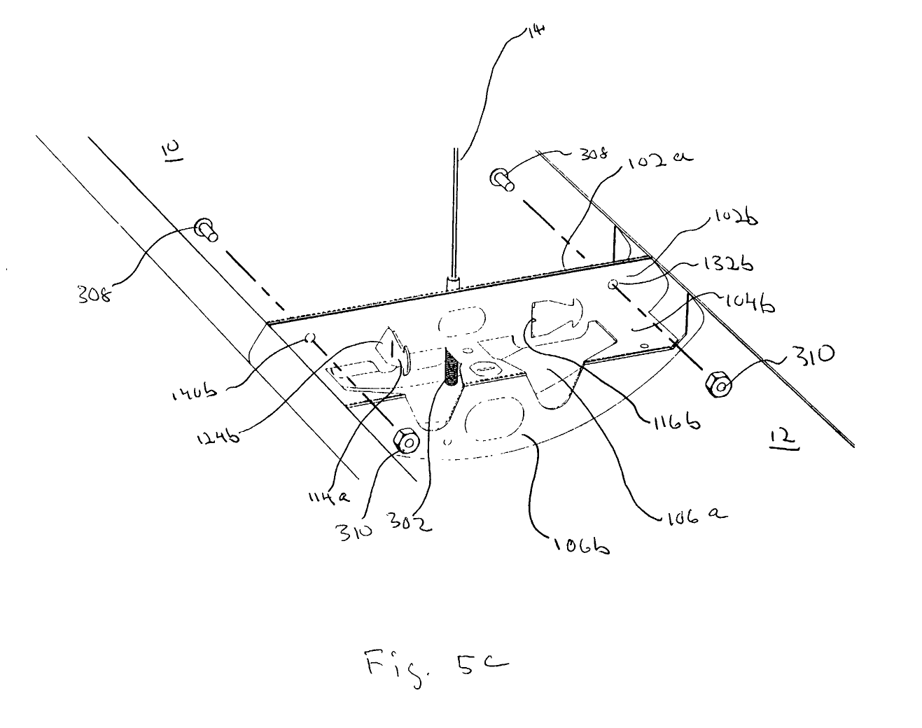

As shown in FIG. 4, connector 100 is then inserted into a module, such as module 12, with wall member 102 aligned with the end 202 of module 12. Connector 100 may be secured in position in module 12 by any suitable method, such as by friction fitting, welding, or attachment to a support/positioning device within module 12. Tab member 114 may be left as cut, temporarily. However, it should be noted that, prior to connecting module 10 to module 12, tab 114 is bent away from wall member 102 to obtain the orientation shown in FIG. 2. Receptacles for the ends of light tubes and wiring are also installed, using the openings described above with reference to FIGS. 2 and 3. For simplicity, the modules in FIGS. 4 and 5 are shown without fluorescent light tubes and without receptacles for mounting the tubes.

The first module of a fixture is generally hung at both ends thereof. Thereafter, the connector of the present invention allows modules to be hung with a single support device at each connection between modules, as illustrated in FIGS. 2 and 5. In FIG. 5(a), a first module 10 has been suspended in position, with a threaded insert 302 mounted in opening 122, and hanger 14 supporting the end where a first connector 100a has been installed. The other end of module 10 is supported in a similar manner by another hanger 14 as shown in FIG. 2. The end of second module 12 which is adjacent module 10 and connector 100a, has been fitted with a second connector 100b. Each of modules 10 and 12 has been prewired with wires for providing electricity to illuminate fluorescent tubes which can be installed in the modules. Wire ends 304 have been left loose and hang from connectors 100a and 100b. Tabs 114a and 114b have been bent outward away from their respective modules 10 and 12. Tab 114a is approximately lined up with opening 124b, and tab 114b is approximately lined up with opening 124a.

Referring now to FIGS. 5(a) and 5(b), installation of second module 12 is continued by moving the modules toward each other as indicated by the dashed arrows in FIG. 5(a). Hooked end 115a of tab 114a is inserted into opening 124b, and hooked end 115a is engaged with wall member 102b of connector 12. Also, hooked end 115b of tab 114b is inserted into opening 124a and engaged with wall member 102a. The engaged hooked ends 115a and 115b support module 12 temporarily and resist pulling apart of the modules, allowing a single worker to use both hands for connection of wire ends 304 and suspension of the other end of module 12. In this regard, it is noted that, in this position, one of the tabs will rest against an upper end of the associated opening and the other tab will rest against a lower end of the associated opening to resist accidental detachment due to either upwardly directed or downwardly directed jarring forces or vibrations. After wire ends 304 have been connected, they can be pushed upwards into the space 306 defined between fixture support members 104a and 104b, light tube support members 106a and 106b, and the adjacent ends of modules 10 and 12. In this position, the other end of module 12 can be hung by a single worker while the module is supported by the connection with the previously hung module 10.

Next, the connectors are moved toward each other until wall members 102a and 102b are butted against each other. Because wall members 102a and 102b are aligned with the ends of modules 10 and 12, respectively, the module ends are also butted against each other, as illustrated in FIG. 5(c). The tapered sides of tabs 114a and 114b, in combination with the tapered sides of openings 124a and 124b, cause the connectors 100a and 100b and the modules 10 and 12 to progressively line up with each other as the connectors are moved toward each other. Connectors 100a and 100b are then secured to each other with suitable fasteners, such as bolts 308 extending through openings 132a and 140b, and through 140a and 132b, respectively, and secured with nuts 310.

It should be noted that the widest portions of the tabs 114a and 114b and of the openings 124a and 124b are sized so that each tab fits closely in the widest portion of the corresponding opening, thereby achieving secure attachment and vertical alignment. The joints 116a and 116b and the openings 124a and 124b are also positioned on the wall members 102a and 102b such that insertion of each tab in the corresponding opening on the adjacent connector will align the modules horizontally as desired. In a preferred embodiment, tab 114 and opening 124 (referring to FIGS. 2 and 3) are positioned such that they are symmetrically disposed on opposing sides of the center of wall member 102 such that the connectors can be of identical construction and interlock in an aligned relationship. Further, as illustrated in FIG. 5, connector 100b is identical to first connector 100a, but rotated 180 degrees (i.e., deployed in mirror image fashion) so that the two wall members 102a and 102b can be butted against each other. However, the connectors need not be identical, as long as the corresponding joints and openings match up with each to align the attached fixtures.

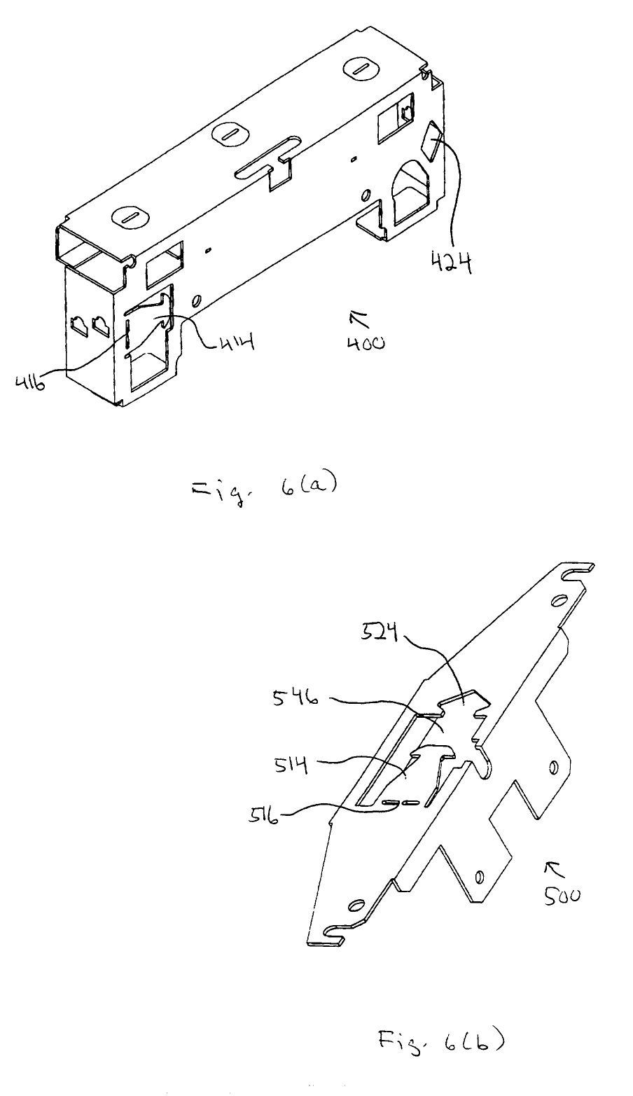

It should be appreciated that shape of each connector may be dictated, in part, by the shape of the fixture module in which it is mounted. Further, connectors in accordance with the present invention may have different configurations of tabs and openings. For example, connector 400 in FIG. 6a has a tab member 414, a joint 416, and an opening 424 for interlocking and alignment with a mating connector. Similarly, in connector 500, shown in FIG. 6b, tab member 514 has been formed to extend into a larger opening 546 from joint 516. A portion 524 of opening 546 is tapered to receive a tab member from an adjacent connector. It should be noted that each connector may include more than one tab member and/or more than one opening for receiving tab members. However, for proper alignment of the fixtures, the corresponding joints and openings should match up with each other.

The fixtures illustrated and described herein are fluorescent light fixtures, although the present invention could be used with other types of fixtures. It is contemplated that the illustrated fixtures may be open on top, as shown in FIGS. 4 and 5(c), or that the fixtures have top covers. Alternatively, the fixtures may be open at the bottom or open at both the top and the bottom. After installation of the illustrated modular fixtures has been completed, fluorescent bulbs can be inserted into the receptacles in the modules.

It should be noted that the other configurations of portions and members of the connectors are possible. However, it is preferred that the connectors are configured so they are functional to aid in supporting the fixtures to which they are mounted and light tubes used in the fixtures, as well as to provide for interlocking, self-aligning connections between modules. The connectors can be formed from any suitable material. Also, the connectors can be mounted to the modules by any suitable method known in the art.

While specific embodiments of this invention have been disclosed, it is expected that those skilled in the art can and will design alternate embodiments of this invention that fall within the scope of the appended claims.

What is claimed is:

1. An apparatus for connecting and aligning modules in an abutting, end-to-end relationship so as to form an elongate fixture, comprising:
an end portion adapted for mounting at an end of a first of said modules, wherein said end portion includes aligning engagement means for receiving a tapered tab connector extending from an adjacent second of said modules and engaging said tapered tab connector such that said first and second modules are constrained to maintain an aligned, end-to-end relationship, said aligning engagement means including structure defining an opening for receiving said tapered tab connector, the opening having a wide central portion and narrower side portions, wherein a first, narrow end of said tab connector can be received within said narrower side portions of said opening and said wide central portion of said opening is dimensioned to securely engage a second, wide end of said tab connector such that said first and second modules are forced into said aligned, end-to-end relationship as said tapered tab connector is progressively received within said opening from said first end to said second end of said tab connector.

2. An apparatus according to claim 1, wherein said end portion comprises a wall member for abutting a wall member of said second module and one of a fixture support member for use in connecting said fixture to a support structure and a light tube support member for use in supporting a light tube within said fixture.

3. An apparatus according to claim 1, wherein said apparatus further comprises:
a second tab memberjoined to said end portion at a joint, said tab member having a wide portion adjacent said joint, a narrow portion, and a tapering portion between said wide portion and said narrow portion.

4. An apparatus according to claim 3, wherein:
said end portion has a center located such that said center is aligned with a central axis of said elongate fixture when said first and second modules are engaged, and said wide portion of said opening and said joint are disposed on opposite sides of said center of said end portion.

5. An apparatus according to claim 3, wherein said tab member terminates in a hook distal from said joint, wherein said hook engages an opening of said second module to facilitate interconnection of said modules.

6. An apparatus according to claim 1, wherein said apparatus is adapted for mounting on an end of said module so as to form an end wall of said module.

7. An apparatus according to claim 1, wherein said apparatus includes means for supportably interconnecting said first module to a support structure.

8. An apparatus according to claim 7, wherein said means for supportably interconnecting includes an insert, mounted on said end portion, for use in suspending said first module from said support structure.

9. An apparatus according to claim 7, wherein said means for supportably interconnecting comprises means for mounting said first module on a wall.

10. An apparatus according to claim 1, wherein said fixtures are electrical fixtures, and said apparatus is adapted to permit passage of an electrical line through said end portion between said first and second modules free from exposure external to said fixture.

11. An apparatus according to claim 10, wherein said fixtures support fluorescent light tubes, and said apparatus is adapted to support one of said light tubes such that an end of said tube is located adjacent to said end portion, thereby minimizing space between ends of tubes installed end-to-end in adjacent modules.

12. An apparatus for connecting and aligning modules in an abutting, end-to-end relationship so as to form an elongate fixture, comprising:
an end portion adapted for mounting at an end of a first of said modules, wherein said end portion includes aligning engagement means for engagement within an opening of an adjacent second of said modules such that said first and second modules are constrained to maintain an aligned, end-to-end relationship, said aligning engagement means including a tab member joined to said body portion at a joint said tab member having a wide portion adjacent said joint a narrow portion and a tapering portion between said wide portion and said narrow portion, said tab member being adapted for engagement with said opening of said adjacent module in first and second interlocking positions where relative longitudinal movement as between said first and second modules is constrained in each of said first and second interlocking positions.

13. An apparatus according to claim 12, wherein said tab member terminates in a hook distal from said joint.

14. An apparatus according to claim 12, wherein said tab member is deployable between first and second positions relative to said end portion, wherein said tab member extends longitudinally from said end portion in one of said positions for engagement with said opening of said second module.

15. An apparatus according to claim 12, wherein said apparatus is adapted for mounting substantially inside said first module with said end portion at an end of said first module.

16. An apparatus according to claim 12, wherein said end portion comprises a wall for abutting a wall of said second module and one of a fixture support member for use in connection said fixture to a support structure and a light tube support member for supporting a light tube within said fixture.

17. An apparatus according to claim 12, wherein said modules are separated stance in said first interlocking position to provide a work space between said modules.

18. A system for connecting and aligning modules in an end-to-end relationship, the system comprising:
at least two fixture modules, each module having a first end and a second end;
first means for use in connecting and aligning said modules, said first means including a first body portion adapted for engagement and flush alignment with said first end of a first one of said modules, said first means including at least one tab member adapted for extension from said body portion beyond said respective end of said respective fixture, said tab member having a joint with said body portion, said tab member having a first width at said joint and tapering to a smaller width distal from said joint; and
second means for use in connecting and aligning said modules, said second means including a second body portion adapted for engagement and flush alignment with said second end of a second one of said modules, and second body portion having therein at least one tapered opening positioned to receive said extended tab member of said first means, the opening having a maximum width selected to accommodate said first width of said tab member such that when said tab member is extended from said body portion and inserted completely through said opening and into said second fixture, said respective first and second ends of said fixtures are butted against and aligned with each other.

19. A system according to claim 18, wherein said first and second means each include at least one tab member and at least one tapered opening.

20. A system according to claim 18, wherein said first and second means are of identical construction.

21. A system according to claim 18, wherein each of said tab members terminates in a hook distal from said joint.

22. A system according to claim 18, wherein said modules are electric light fixtures and each of said connecting means defines a space for passage of electrical wires.

23. A system according to claim 18, wherein said modules are adapted for utilizing fluorescent tubes in adjacent modules and said first and second means allow for substantially butting interconnection of said adjacent modules so as to minimize space between said fluorescent tubes.

24. A system according to claim 18, wherein said first and second means are adapted to accommodate fasteners for securing said modules to each other.

25. An apparatus according to claim 18, wherein:
said first body portion comprises a first wall member and one of a first fixture support member and a first light tube support member; and
said second body portion comprises a second wall member and one of a second fixture support member and a second light tube support member.

26. A system according to claim 25, wherein said first and second wall members are deployed in a mirror image relationship.

27. A system according to claim 25, wherein each of said first and second wall members is in flush alignment with the respective end of a respective one of said modules.

28. A method for connecting and aligning modules in an end-to-end relationship, a first one of said modules having a first connector mounted at a first end of said first module, a second module having a second connector mounted at a second end of said second module, said first connector including a first body portion and at least one tapered opening in said first body portion, said second connector including a second body portion and at least one tab member extending from said second body portion and away from said second module, said method comprising the steps of:
securing said first module to a support structure;
engaging said tab member of said second connector into said opening in said body portion of said first connector such that said first and second modules are interlocked in a first position where relative motion between said modules is constrained with respect to a first longitudinal direction; and
moving said second module toward said first fixture to progressively receive said tab member in the opening, such that said modules are engaged in a second position wherein said first and second ends of said respective first and second modules are butted against each other with said fixtures in said end-to-end relationship;
wherein said tab member and said opening are positioned relative to said respective first and second body portions for alignment of said modules.

29. A method according to claim 28, wherein said modules are part of a light fixture, and said method includes the additional step of:
connecting wires between said modules with said modules in said first position.

30. A method according to claim 28, comprising the additional step of securing said first and second modules to each other with said modules in said second position.

31. A method according to claim 28, wherein:
each of said connectors includes at least one tab member and at least one opening, each of said tab members dimensioned to engage a corresponding opening in the body portion of the other of said connectors; and
said engaging step includes extending each of said tab members into the corresponding opening in the body portion of said other connector to engage said first and second connectors in said first position.

32. A method according to claim 28, further comprising the step of securing said second module to a support structure with said modules in said first position.

33. A method for making an interlocking connector for interconnecting and aligning modules of a modular fixture, comprising the steps of:
providing a workpiece;
dimensioning said workpiece so as to allow for mounting of the workpiece within an end of one of said modules;
bending said workpiece to define an end wall and a supporting wall on opposite sides of a bend, wherein said supporting wall can be used to support a fixture element within said one module; and
forming a tab connector in said end wall for use in connecting said module to an adjacent module of said fixture.

34. A method as set forth in claim 33, wherein some of said steps of dimensioning and forming are selected from laser cutting and punching said workpiece.

35. A method as set forth in claim 33, further comprising the step of forming a tapered opening in said end wall, said tapered opening including a wide portion and a narrow portion.

36. A method as set forth in claim 35, wherein said step of forming a tapered opening comprises using a technique selected from laser cutting and punching said end wall.

37. A method as set forth in claim 33, wherein said step of forming comprises cutting said end plate to define said tab such that said tab includes a widened portion at a first end thereof and a hook at a second end thereof.
